(19) United States
(12) Patent Application Publication
(10) Pub. No.: US 2022/0283285 A1
(43) Pub. Date: Sep. 8, 2022

(54) MULTISTATIC RADAR, SUCH AS FOR TRAJECTORY IDENTIFICATION OF SMALL TARGETS

(71) Applicant: Lawrence Livermore National Security, LLC, Livermore, CA (US)

(72) Inventors: Sean Kenneth Lehman, Pleasanton, CA (US); Emeraldo V. Baluyot, Mountain House, CA (US); Jae Jeon, Livermore, CA (US)

(21) Appl. No.: 17/197,585

(22) Filed: Mar. 10, 2021

Related U.S. Application Data
(60) Provisional application No. 62/988,293, filed on Mar. 11, 2020.

(51) Int. Cl. G01S 13/58; G01S 13/02; G01S 13/90

(52) U.S. Cl. CPC G01S 13/581; G01S 13/0209; G01S 13/9029

(57) ABSTRACT

Multistatic radar systems and associated methods are disclosed herein. In some embodiments, a multistatic radar system can include multiple radar transmitters and multiple radar receivers. The transmitters are configured to generate radio-frequency (RF) signals in a target volume, and the receivers are configured to receive the RF signals after the RF signals are reflected off an object moving through the target volume. The transmitters and the receivers can be spaced apart and aperiodically positioned about the target volume. The receivers can sample and digitize the reflected RF signals at an RF frequency. The radar system further includes a processing device configured to determine a property of the object based on the sampled reflected RF signals.

### STATEMENT REGARDING FEDERALLY SPONSORED RESEARCH

The United States Government has rights in this invention pursuant to Contract No. DE-AC52-07NA27344 between the U.S. Department of Energy and Lawrence Livermore National Security, LLC, for the operation of Lawrence Livermore National Laboratory.

### TECHNICAL FIELD

The present technology generally relates to multistatic radar systems, such as broadband multistatic radar systems for volume imaging and target tracking.

### BACKGROUND

Radar is a detection system that uses radio waves to determine the range, angle, velocity, position, track, and/or other characteristics of objects. Radar can be used to detect and/or identify aircraft, ships, spacecraft, guided missiles, motor vehicles, weather formations, and other types of objects. In general, a radar system consists of (i) a transmitter configured to generate electromagnetic waves (e.g., radio or microwave waves, millimeter waves, etc.) in a target volume, (ii) a receiver configured to receive the waves after they reflect off one or more objects in the target volume, and (iii) a processor configured to determine properties of the one or more objects based on the received waves.

In monostatic radar systems, the signal transmitted by a transmitter is received only by the receiver of that same transceiver. Bistatic radar systems use separate transmit and receive antennas. Multistatic radar systems combine multiple, spatially diverse, transmitters and receivers and fuse the data from some or all the systems to gain additional information about objects in the target volume. The spatial diversity afforded by multistatic systems allows different aspects of the object to be “viewed” simultaneously.

More specifically, in multistatic radar systems, each transmitter transmits in sequence, but the return signal is collected by multiple receivers, generally all the receivers. If the system has N transmitters and M receivers the system collects M×N return signals. Each return signal received by a receiver represents the reflection from each object in the target volume. For example, if there are three objects, the return signal received by a receiver will include three return pulses corresponding to the reflection of objects. The time-of-arrival of each return pulse represents the time between the transmitting of a signal and receiving of a return pulse. The set of M×N time-of-arrivals from each transmitter and receiver pair for each object is referred to as a “look.”

Many conventional multistatic radar systems require that receivers and transmitters be positioned periodically to facilitate the data fusion. Additionally, it is difficult or impossible to accurately detect small, fast moving objects using conventional multistatic radar systems.

### BRIEF DESCRIPTION OF THE DRAWINGS

FIG. 1 is a schematic diagram of a radar system in accordance with embodiments of the present technology.

FIG. 2 is a block diagram illustrating the components of a receiver and a transmitter of the radar system of FIG. 1 in accordance with embodiments of the present technology.

FIG. 3 is a flow diagram that illustrates the overall processing and operation of the radar system of FIG. 1 in accordance with embodiments of the present technology.

### DETAILED DESCRIPTION

The present technology is generally directed to multistatic radar systems. In some embodiments, a multistatic radar system can include multiple radar transmitters and multiple radar receivers. The transmitters are configured to generate radio-frequency (RF) signals in a target volume, and the receivers are configured to receive the RF signals after the RF signals are reflected off an object moving through the target volume. In some embodiments, the transmitters and the receivers can be spaced apart and aperiodically/irregularly positioned about the target volume. In some embodiments, the receivers can sample and digitize the reflected RF signals at an RF frequency. The radar system further includes a processing device configured to determine a property/characteristic of the object based on the sampled, reflected RF signals. The characteristic can include, for example, (i) a three-dimensional (3D) track of the object through the target volume, (ii) a multistatic Doppler velocity estimate of the object, (iii) a radar cross-section (RCS) evolution of the object as a function of time, (iv) a volume movie of the object (e.g., a 3D track progression over time), and/or (v) an inverse synthetic aperture radar (ISAR) image of the object.

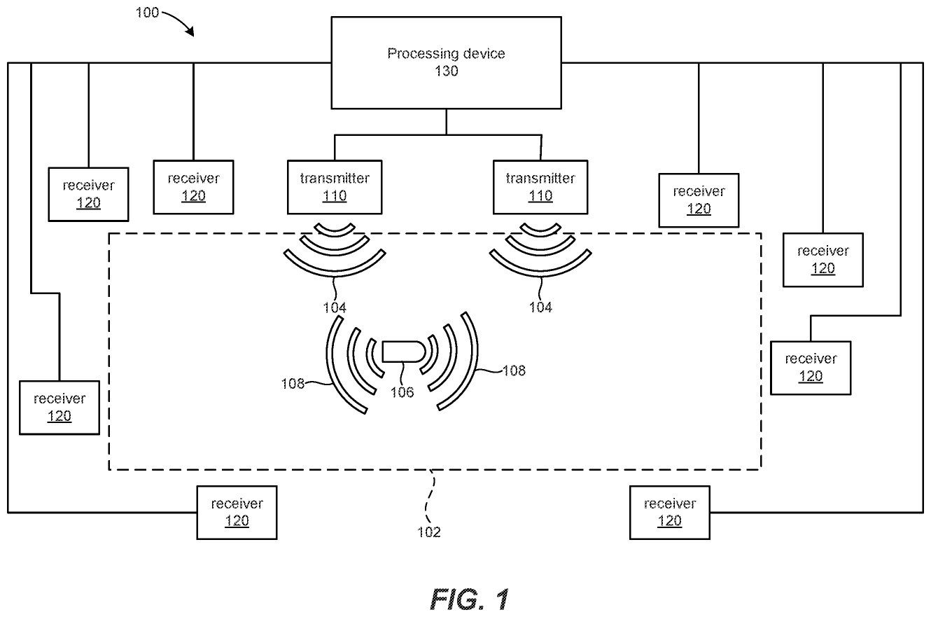

Specific details of several embodiments of the present technology are described herein with reference to FIGS. 1-3. However, the present technology may be practiced without some of these specific details. In some instances, well-known structures and techniques often associated with radar systems, radar transmitters, radar receivers, radar signal processing, etc., have not been shown/described in detail so as not to obscure the present technology. The terminology used in the description presented below is intended to be interpreted in its broadest reasonable manner, even though it is being used in conjunction with a detailed description of certain specific embodiments of the disclosure. Certain terms may even be emphasized below; however, any terminology intended to be interpreted in any restricted manner will be overtly and specifically defined as such in this Detailed Description section.

The accompanying figures depict embodiments of the present technology and are not intended to be limiting of its scope. The sizes of various depicted elements are not necessarily drawn to scale, and these various elements can be arbitrarily enlarged to improve legibility. Component details can be abstracted in the figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

The headings provided herein are for convenience only and should not be construed as limiting the subject matter disclosed.

### I. Selected Embodiments of Multistatic Radar Systems and Devices

FIG. 1 is a schematic diagram of a radar system 100 in accordance with embodiments of the present technology. In the illustrated embodiment, the radar system 100 is a multistatic radar system including a plurality of transmitters 110 and a plurality of receivers 120 distributed in/around a target volume 102. Some or all of the transmitters 110 and the receivers 120 can be communicatively coupled to a processing device 130 via one or more wired and/or wireless communication paths. In general, the transmitters 110 are configured to generate (e.g., launch) electromagnetic waves 104 in/through all or a portion of the target volume 102. The electromagnetic waves 104 can reflect/scatter off one or more objects 106 in the target volume 102 as reflected electromagnetic waves 108. Some or all of the receivers 120 can receive the reflected electromagnetic waves 108 and convert the reflected electromagnetic waves 108 into digital output signals. The processing device 130 can receive the output signals from the receivers 120 and calculate one or more properties of the object 106 (e.g., a velocity, trajectory, radar cross-section, etc.) based on the output signals.

The object 106 can be any object that an operator of the radar system 100 desires to track/monitor and, in some embodiments, can be a small and fast-moving object. For example, the object 106 could be a bullet, one or more portions of an explosive, and/or other types of projectiles. Accordingly, the target volume 102 can be a public or private gathering space (e.g., a concert venue, sports arena, public street or square, etc.), an active military environment, a shooting range, or other area in which projectile monitoring is desired. In other embodiments, for example, the object 106 can be a moving vehicle (e.g., a drone), portion of an asteroid, portion of an explosive, meteorological component of a storm (e.g., rain, hail, particulate, etc.), animal (e.g., a bat, bird, insect, etc.), and/or other object of interest. Accordingly, the target volume 102 can be, for example, a monitored airspace, volume of space, etc.

In some embodiments, the transmitters 110 and the receivers 120 can be positioned arbitrarily relative to one another and the target volume 102. For example, in the illustrated embodiment the transmitters 110 and the receivers 120 are aperiodically (e.g., irregularly) spaced apart from one another about the target volume 102. The transmitters 110 and/or the receivers 120 can be stationary or moving relative to the target volume 102, and can be airborne, ground-based, and/or satellite-based. For example, where the target volume 102 is a public street or square, the transmitters 110 and the receivers 120 can be mounted to buildings adjacent the street or square, on drones hovering/moving above the street or square, to ground-based components (e.g., vehicles, backpacks, racks, etc.), etc. Moreover, the radar system 100 can include more or fewer than the two illustrated transmitters 110 and the eight illustrated receivers 120. In some embodiments, increasing the number of the transmitters 110 and/or the receivers 120 can increase the resolution of the radar system 100—allowing more precise tracking and monitoring of the object 106. Similarly, increasing the number of the receivers 102 can increase the signal to noise ratio (SNR) of the radar system 100.

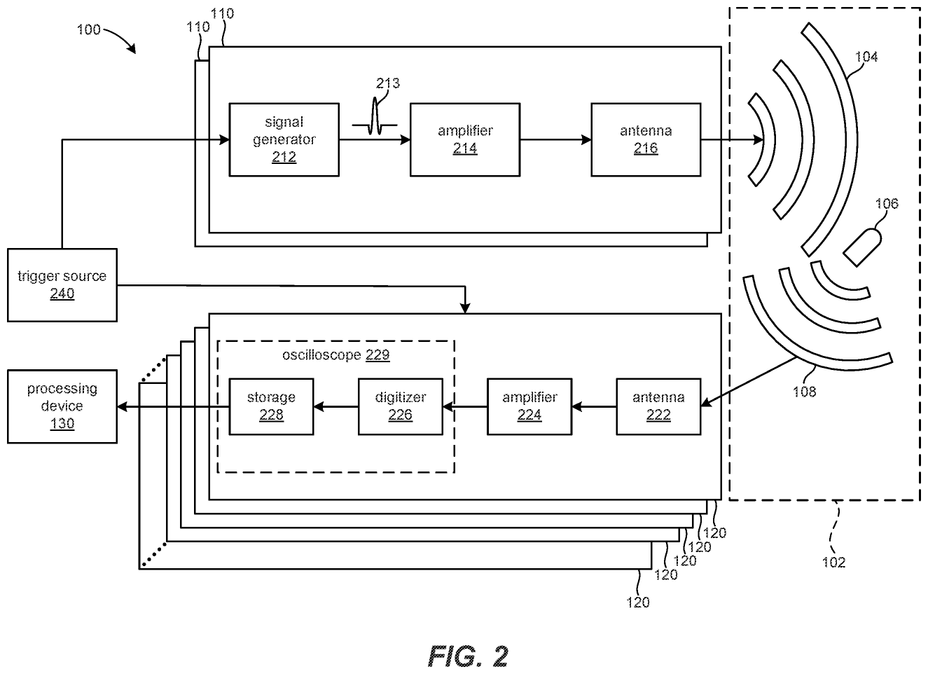

FIG. 2 is a block diagram illustrating the components of one of the transmitters 110 and one of the receivers 120 of the radar system 100 in accordance with embodiments of the present technology. In the illustrated embodiment, the transmitter 110 includes a signal generator 212, an amplifier 214, and an antenna 216. The signal generator 212 is configured to generate a signal pulse or impulse 213 having a specified shape, such as a sinusoidal, Gaussian windowed sinusoidal, symmetric upward chirp, square, tapered, or other shape. In some embodiments, the signal pulse 213 is a near-first derivate of a Gaussian waveform with a full width at half maximum (FWHM) of less than 10 nanoseconds (e.g., less than 1 nanosecond, about 0.5 nanosecond, etc.).

The amplifier 214 is configured to receive and amplify the signal pulse 213. In some embodiments, the amplifier 214 is a power amplifier having an output power of about 50 watts and a bandwidth of between about 2-20 gigahertz (e.g., between about 4-18 gigahertz, between about 6-18 gigahertz, etc.). In some embodiments, the amplifier 214 is a broadband 50 watt traveling wave tube amplifier.

The antenna 216 is configured to receive the amplified signal pulse 213 from the amplifier 214 and to generate the electromagnetic waves 104. In some embodiments, the antenna 216 can be a planar horn or a standard horn. In some embodiments, the electromagnetic waves 104 can be radiofrequency (RF) waves having (i) a frequency range of between about 2-100 gigahertz (e.g., between about 6-13 gigahertz, between about 8-13 gigahertz, between about 3-12 gigahertz, between about 30-90 gigahertz, etc.), (ii) a bandwidth of between about 4-6 gigahertz (e.g., about 5 gigahertz), and (iii) a wavelength of between about 2.0-4.0 centimeters (e.g., between about 2.3-3.7 centimeters). In some embodiments, the transmitter 110 is configured to generate (e.g., pulse) successive ones of the electromagnetic waves 104 between about every 5-100 picoseconds (e.g., about every 12.5 picoseconds). In some embodiments, the antennas 216 of multiple ones of the transmitters 110 can be operably coupled to the amplifier 214 and the signal generator 212 via a switch (e.g., an RF switch; not shown) to enable the synchronous operation of the transmitters 110. In some embodiments, the switch can be a broadband absorptive single pole double throw (SPDT) switch.

Accordingly, the transmitters 110 are configured to generate time-domain pulsed broadband electromagnetic waves 104. In some embodiments, the electromagnetic waves 104 do not include a carrier signal (e.g., an RF carrier signal). That is, the amplified signal pulse 213 is not used to modulate a radar carrier signal. In one aspect of the present technology, omitting a carrier signal can increase the resolution of the radar system 100 given, for example current technological limitations. Moreover, in some embodiments the radar system 100 is configured such that only one pulse of the electromagnetic waves 104 is in the air within the target volume 102 at a given time. In particular, where the object 106 is moving very quickly through the target volume 102 (e.g., moving between about 300 meters per second to 2000 meters per second or greater), it may be difficult or even impossible to generate multiple simultaneous pulses within the target volume 102 while the object 106 moves therethrough. In contrast, conventional pulse-Doppler radar systems are typically configured to generate multiple pulses in the air at the same time for evaluating objects traveling at slower velocities (e.g., up to about 500 km/hr).

In the illustrated embodiment, the receiver 120 includes an antenna 222, an amplifier 224, a digitizer 226, and a storage or memory 228. The antenna 222 is configured to receive the reflected electromagnetic waves 108 from/off the object 106 and to output an RF signal indicative of the reflected electromagnetic waves 108. In some embodiments, the antenna 222 can be a planar horn or a standard horn, such as a broadband double-ridge horn antenna. In some embodiments, the antenna 222 can be one or a sub-array of a plurality of antennas positioned/formed on a chip.

The amplifier 224 is configured to receive and amplify the RF signal from the antenna 222. In some embodiments, the amplifier 224 is a low noise amplifier having a gain of greater than about 40 decibels and a bandwidth of between about 2-20 gigahertz (e.g., between about 4-18 gigahertz). In some embodiments, the bandwidth of the amplifier 224 can be greater than or about equal to the bandwidth of the electromagnetic waves 104.

The digitizer 226 is configured to receive the amplified signal from the amplifier 224 (e.g., a “radar return”) and to convert/sample the analog radar return to a digital signal. In some embodiments, the digitizer 226 has a bandwidth of greater than about 30 gigahertz and a sampling rate of about 40 giga-samples per second (GSa/s) or greater. In one aspect of the present technology, the digitizer 226 is configured to sample the radar return at RF frequencies. The storage 228 receives and stores the digital samples from the digitizer 226 as voltage time series:

vₘₙ(t_{0,m,n}+nₜΔt,nₛΔtₛ)

Where:
m is the receiver index, m=1 . . . N_{rcv}
n is the transmitter index, n=1 . . . N_{src}
N_{rcv} is the number of receivers
N_{src} is the number of transmitters
nₜ is the fast time index
Δt is the fast time sample interval
nₛ is the slow time index

$$Δ {t}_{s} is the slow time sample interval , {t}_{s} ≡ \frac{{N}_{src}}{Pulse Repetition Frequency}$$

t_{0,m,n} are the fast time origins determined by calibration

In some embodiments, the digitizer 226 and the storage 228 can be part of an oscilloscope 229. In some embodiments, the oscilloscope 229 can have multiple channels (e.g., two, four, eight, or more channels) such that the oscilloscope 229 can be operably coupled to the antennas 222 and the amplifiers 224 of multiple ones of the receivers 120.

In the illustrated embodiment, the radar system 100 further includes a trigger source 240 operably coupled to the transmitters 110 and the receivers 120 and configured to trigger/start operation thereof. For example, the trigger source 240 can trigger the signal generator 212 to begin generating the signal pulses 213 and/or the storage 228 to begin and/or continue storing the radar return data for further analysis and processing. In some embodiments, the trigger source 240 can be an optical gate, infrared sensor, or other optical component configured to output a command signal (e.g., a record command, a start command, a through the lens (TTL) burst, etc.) to the transmitters 110 and/or the receivers 120 after optically detecting the object 106. For example, where the object 106 is a bullet, the trigger source 240 can be a photogate placed in the line-of-sight of the gun used to fire the bullet. In other embodiments, the trigger source 240 can be an audio sensor configured to audibly detect the object 106 (e.g., audibly detect movement of the object 106, firing of a gun, etc.). In yet other embodiments, the trigger source 240 can be a manual trigger operated by an operator of the radar system 100. In some embodiments, the trigger source 240 can be omitted and the radar system 100 can operate continuously or for a predetermined period.

Referring to FIGS. 1 and 2 together, the processing device 130 can be communicatively coupled to all or a portion of the transmitters 110, the receivers 120, and the trigger source 240. In general, the processing device 130 is configured to process the radar return data to determine one or more properties/characteristics of the object 106. In some embodiments, the processing device 130 can aggregate/collect the radar return data from the receivers 120 into a data block for each of the individually-pulsed electromagnetic waves 104. The data block includes the time series data for each of the receivers 120 and the transmitters 110. In some embodiments, the receivers 120 can output the digitized radar data to the processing device 130 in real-time or near real-time while, in other embodiments, the receivers 120 can upload the data to the processing device 130 periodically and/or at a selected time.

The processing device 130 can comprise a processor and a non-transitory computer-readable storage medium that stores instructions that when executed by the processor, carry out the functions attributed to the processing device 130 as described herein. Although not required, aspects and embodiments of the present technology can be described in the general context of computer-executable instructions, such as routines executed by a general-purpose computer, e.g., a server or personal computer. Those skilled in the relevant art will appreciate that the present technology can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers, systems on chip (SoC), field programmable gate arrays (FPGAs), and the like. The present technology can be embodied in a special purpose computer or data processor that is specifically programmed, configured or constructed to perform one or more of the computer-executable instructions explained in detail below. Indeed, the term “computer” (and like terms), as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines can be located in both local and remote memory storage devices. Aspects of the invention described below can be stored or distributed on computer-readable media, including magnetic and optically readable and removable computer discs, stored as in chips (e.g., EEPROM or flash memory chips). Alternatively, aspects of the invention can be distributed electronically over the Internet or over other networks (including wireless networks). Those skilled in the relevant art will recognize that portions of the present technology can reside on a server computer, while corresponding portions reside on a client computer. Data structures and transmission of data particular to aspects of the present technology are also encompassed within the scope of the invention.

### II. Selected Embodiments of Methods of Radar Data Collection and Processing

The processing device 130 is configured to process the radar return data to determine one or more properties/characteristics of the object 106 such as, for example, (i) three-dimensional (3D) tracks of the object 106 through the target volume 102, (ii) multistatic Doppler velocity estimates of the object 106, (iii) a radar cross-section (RCS) evolution of the object 106 as a function of time, (iv) volume movies of the object 106 (e.g., a 3D track progression over time), and/or (v) inverse synthetic aperture radar (ISAR) images of the object 106. In some embodiments, the processing device 130 is configured to first pre-process the radar return data to remove noise, spurious signals, etc. For example, the processing device 130 can (i) filter the frequency domain of the radar return data to remove any cellular interference or other interference or noise (e.g., hostile/intentional interference with the radar system 100), (ii) align data about the object with data about the background (e.g., the target volume 102) to remove jitter induced in the radar system 100, (iii) block average in slow time to reduce the data while removing slow time trends, and/or (iv) apply whitening across the fast time data to reduce background noise.

To generate 3D tracks/trajectories of the object 106, the processing device 130 can employ a Newtonian state space model such as, for example:

$$r ( {t}_{s} ) = {r}_{0} + {ν}_{0} {t}_{s} + \frac{1}{2} {a}_{0} {t}_{s}^{2} + \frac{1}{3 !} {j}_{0} {t}_{s}^{3} + \frac{1}{4 !} {s}_{0} {t}_{s}^{4} + …$$

Where:
r(tₛ) is the 3D track of the object 106 as a function of slow time
r₀ is the initial position of the object 106
v₀ is the initial velocity of the object 106
a₀ is the initial acceleration of the object 106
j₀ is the initial jerk of the object 106
s₀ is the initial jounce or snap of the object 106

In some embodiments, higher order terms in the Newtonian displacement model (e.g, j₀, s₀, etc.) can be omitted if the object 106 is not expected to have a complex trajectory. In some embodiments, the PRF of the radar system 100 can be between about 300-400 kilohertz (e.g., between about 200-2000 kilohertz, about 312.5 kilohertz, about 1 megahertz, etc.), and the slow time sample interval Δtₛ can be between about 1-10 microseconds (e.g., about 3.2 microseconds).

The processing device 130 can further apply an unscented Kalman filter (UKF) to derive the 3D trajectory from the moveout measurements for the object:

hₘₙ(tₛ)=|r_{src,n}(tₛ)−r(tₛ)|+|r(tₛ)−r_{rcv,m}(tₛ)|

Where:
r_{src,n}(tₛ) is the location of the n^{th} one of the transmitters 110
r_{rcv,m}(tₛ) is the location of the m^{th} one of the receivers 120

The locations r_{src,n} and r_{rcv,m} can be determined from a calibration process as described in greater detail below.

To generate Doppler velocity estimates (e.g., multistatic and/or bistatic velocity estimates) for the object 106, the processing device 130 employing an algorithm given by, for example:

v_{D}(tₛ)=½((v_{src,n}(tₛ)−v₀(tₛ))·n_{src,n}(tₛ)+(v_{rcv,m}(tₛ)−v₀(tₛ))·n_{rcv,m}(tₛ))

Where the unit vectors are:

$${n}_{src , n} ( {t}_{s} ) = \frac{{r}_{0} ( {t}_{s} ) - {r}_{src , n} ( {t}_{s} )}{\vert {r}_{0} ( {t}_{s} ) - {r}_{src , n} ( {t}_{s} ) \vert}$$

$${n}_{rcv , m} ( {t}_{s} ) = \frac{{r}_{0} ( {t}_{s} ) - {r}_{rcv , m} ( {t}_{s} )}{\vert {r}_{0} ( {t}_{s} ) - {r}_{rcv , m} ( {t}_{s} ) \vert}$$

Where:
v_{src,n}(tₛ) is the velocity of the n^{th} one of the transmitters 110
v_{rcv,m}(tₛ) is the velocity of the m^{th} one of the receivers 120
v₀(tₛ) is the velocity of the object 106

In some embodiments, the processing device 130 can further determine the RCS of the object 106 and track the evolution of the RCS as a function of time along the track of the object 106. In some embodiments, the processing device 130 can generate a volume movie of the object 106 including information proportional to the scattering amplitude of the object 106 over time. More specifically, for example, the processing device 130 can utilize a delay, sum, and scale migration algorithm, spherical beamforming, and/or matched field processing algorithm to generate the volume movie. The volume movie can provide information about the motion of the object 106 such as, for example, it's rotation, corkscrewing, dodging rate, and/or fluctuating morphology.

In some embodiments, the processing device 130 can use the determined 3D trajectory of the object 106 for ISAR processing to generate 2D or 3D reconstructions of the object 106 that provide increased spatial resolution. That is, the processing device 130 can utilize the determined motion of the object 106 for ISAR image processing rather than or in addition to the known motion of the transmitters 110 and/or the receivers 120.

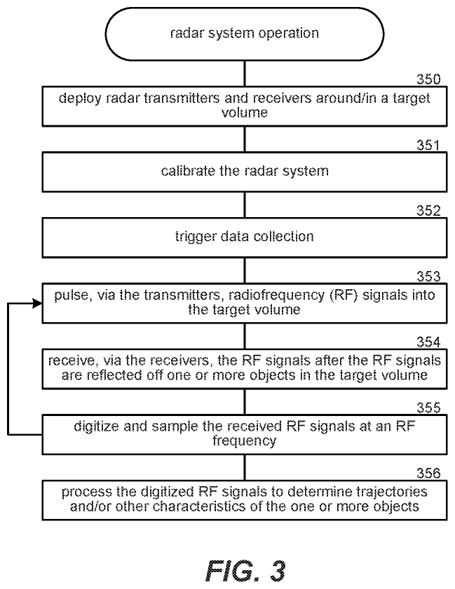

FIG. 3 is a flow diagram that illustrates the overall processing and operation of the radar system 100 in accordance with embodiments of the present technology. Aspects of the processing and operation are described in the context of the radar system 100 shown in FIGS. 1 and 2 although, in other embodiments, some or all of the processing can be carried out in other suitable systems.

In block 350, an operator can deploy the transmitters 110 and the receivers 120 around/in the target volume 102. In some embodiments, the transmitters 110 and the receivers 120 can be (i) positioned arbitrarily (e.g., aperiodically, irregularly, randomly, etc.) relative to one another and the target volume 102, (ii) stationary or moving relative to the target volume 102, and (iii) airborne and/or ground-based.

In block 351, the radar system 100 is calibrated. In some embodiments, calibrating the radar system 100 can include determining the positions and/or orientations of the transmitters 110 and the receivers 120 relative to one another and/or relative to the target volume 102. For example, one or more calibration objects (e.g., spheres) with known dimensions and positions can be positioned within the target volume 102, and the transmitters 110 can emit pulsed RF signals (e.g., the electromagnetic waves 104) that scatter of the objects. The processing device 130 can then process the reflected RF signals (e.g., the electromagnetic waves 108) received by the receivers 120 to calibrate the radar system 100 based on the known characteristics of the calibration objects. In some embodiments, the radar system 100 can be repeatedly or continuously calibrated during operation.

Optionally, in block 352 the trigger source 240 can trigger radar data collection. For example, the trigger source 240 can trigger (i) the signal generators 212 of the transmitters 110 to begin generating the signal pulses 213 and/or (ii) the storages 228 of the receivers 120 to begin and/or continue storing the radar return data for further analysis and processing.

In block 353, the transmitters 110 generate pulsed radio-frequency (RF) signals in the target volume 102 without modulating the RF signals on a carrier signal. In block 354, the receivers 120 receive the pulsed RF signals after the RF signals are reflected off the object 106. In block 355, the receivers 120 and/or the processing device 130 digitize and sample the received RF signals at an RF frequency. In block 356, the processing device 130 can process the digitized RF signals to determine trajectories, velocities, radar cross-sections, and/or other characteristics of the object 106 in the target volume 102, as described in detail above.

### III. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A radar system, comprising:
multiple radar transmitters configured to generate radio-frequency (RF) signals in a target volume;
multiple radar receivers configured to receive the RF signals after the RF signals are reflected off an object moving through the target volume, wherein the receivers and the transmitters are configured to be aperiodically spaced apart about the target volume; and
a processing device operably coupled to the receivers configured to determine a trajectory of the object through the target volume based on the reflected RF signals.

2. The radar system of claim 1 wherein the receivers are configured to sample the reflected RF signals at an RF frequency.

3. The radar system of claim 1 wherein the RF signals do not include a carrier signal.

4. The radar system of claim 1 wherein the processing device is further configured to determine a multistatic Doppler velocity of the object based on the reflected RF signals.

5. The radar system of claim 1 wherein the processing device is further configured to determine a radar cross-section evolution of the object over time based on the reflected RF signals.

6. The radar system of claim 1 wherein the processing device is further configured to generate a volume movie of the object based on the reflected RF signals.

7. The radar system of claim 1 wherein the processing device is further configured to generate an inverse synthetic aperture radar image of the object based on (a) the reflected RF signals and (b) the determined trajectory of the object.

8. The radar system of claim 1 wherein the object is a bullet.

9. The radar system of claim 1 wherein the receivers and the transmitters are configured to be movably positioned about the target volume.

10. The radar system of claim 1, further comprising a trigger source operably coupled to the transmitters and the receivers, wherein the trigger source is configured to trigger (a) the transmitters to generate the RF signals and (b) the receivers to store data associated with the reflected RF signals.

11. The radar system of claim 10 wherein the trigger source is an optical gate.

12. The radar system of claim 1 wherein the RF signals are broadband RF signals having a bandwidth of between about 30-90 gigahertz.

13. A multistatic radar system for determining a characteristic of a moving object, the radar system comprising:
multiple radar transmitters configured to generate radio-frequency (RF) signals, wherein the RF signals do not include a carrier signal;
multiple radar receivers configured to receive the RF signals after the RF signals are reflected off the object, wherein the receivers are configured to sample the reflected RF signals at an RF frequency; and
a processing device operably coupled to the receivers and configured to determine the characteristic of the object based on the reflected RF signals.

14. The radar system of claim 13 wherein the receivers and transmitters are aperiodically positioned relative to one another.

15. The radar system of claim 13 wherein the characteristic is a radar cross-section evolution of the object over time.

16. The radar system of claim 13 wherein the characteristic is a volume movie of the object.

17. The radar system of claim 13 wherein the characteristic is a trajectory of the object, and wherein the processing device is further configured to generate an inverse synthetic aperture radar image of the object based on (a) the reflected RF signals and (b) the determined trajectory of the object.

18. The radar system of claim 13 wherein the RF signals are broadband RF signals having a bandwidth of between about 30-90 gigahertz.

19. A method for determining a characteristic of a moving object, the method comprising:
generating, via multiple spaced apart radar transmitters, pulsed radio-frequency (RF) signals in a target volume without modulating the RF signals on a carrier signal;
receiving, via multiple spaced apart radar receivers, the RF signals after the RF signals are reflected off the object;
digitizing the reflected RF signals at an RF frequency; and
processing the digitized RF signals to determine the characteristic of the object.

20. The method of claim 19 wherein the radar transmitters are aperiodically positioned relative to one another.
